(19) United States
(12) Patent Application Publication
(10) Pub. No.: US 2025/0311737 A1
(43) Pub. Date: Oct. 9, 2025

(54) BAKED GOODS

(71) Applicant: Intercontinental Great Brands LLC, East Hanover, NJ (US)

(72) Inventors: Chen Xiao Ping, Suzhou (CN); Grace Chen, Suzhou (CN); Huixin Du, Suzhou (CN); Manhu Gu, Suzhou (CN)

(21) Appl. No.: 18/570,281

(22) PCT Filed: Jun. 27, 2022
(86) PCT No.: PCT/US2022/035096

§ 371 Date: Dec. 14, 2023

(30) Foreign Application Priority Data
Jun. 29, 2021 (CN) 202110730596.0

(51) Int. Cl. A21D 2/18; A21D 13/066; A21D 13/80

(52) U.S. Cl. CPC A21D 2/186; A21D 2/183; A21D 13/066; A21D 13/80

(57) ABSTRACT

Biscuits and cookies are provided that do not brown significantly upon baking. In some forms, the biscuits and cookies may have L* values of 85 or greater.

### FIELD

The present disclosure relates to baked products with reduced browning caused by baking, and methods of making such products.

### BACKGROUND

Baked goods come in a variety of forms, with varying appearances, textures, flavors, and other characteristics. In particular, biscuits such as cookies and the like are provided in a variety of shapes, sizes, and thicknesses. Some forms of cookies optionally contain fillings encapsulated in, or sandwiched between, layers of baked dough, or contain one or more of a wide variety of inclusions, coatings, or toppings. Inclusions vary the texture and/or flavor of the cookie, providing added crunch, chewiness, creaminess, or other characteristics.

It is known to provide baked goods, especially biscuits and cookies, with a variety of colors and other decorative aspects. However, successfully achieving a given coloration in a baked good, and especially providing a white or nearly white product, is extremely challenging. Normally, baked products brown during the baking process, and therefore it is extremely difficult to provide products with a white appearance. When colors are added, any added colorants must overcome the inherent color of the baked good, which may range from light to dark brown depending on the type of baked good, colors added by various ingredients used to make the baked good, and browning caused by baking conditions.

### SUMMARY

Biscuits or cookies, and doughs for making biscuits or cookies, may be provided that have a CIELAB color space L* value of about 85 or greater, and that yet have taste, texture, and other properties that are similar to their traditional counterparts made with traditional processes. Such products may also have additional advantages, such as having low levels of gluten or being completely gluten-free. As used herein, “free of gluten” or “gluten-free” refers to a baked good having no more than the maximum amount of gluten permissible under one or more definitions of “gluten-free” according to applicable standards or regulations. For instance, in the United States 20 ppm gluten or less is considered “gluten-free” per FDA regulations.

In some aspects, biscuits are manufactured containing one or more pre-gelatinized starch and/or one or more of native starch, such as potato starches, corn starches, rice starches, or wheat starches. In some forms, the baked good may include combinations of pre-gelatinized starch, native starch, and gums to yield a dough that has similar properties to traditional doughs made with traditional wheat flour but that does not brown upon baking. In some forms, the dough may additionally contain up to about 5 wt. % flour, such as wheat flour, potato flour, or corn flour, (and up to about 5 wt. % of a concentrated fiber ingredient such as oat fiber, rice fiber, wheat fiber, or the like. Doughs for making such baked goods are also described herein.

In some forms, a baked biscuit or cookie may be provided that comprises about 3-17 wt. % pre-gelatinized starch and about 25-60 wt. % of a native starch selected from the group comprising potato starch and corn starch. In some forms, the biscuit or cookie has a L* of 85 or greater (85-100) after full baking. The biscuit or cookie may be gluten-free in some embodiments, while in other embodiments may contain wheat flour, preferably below about 5 wt. %. In some forms, the biscuit or cookie further comprises native corn starch, for instance about 25-60 wt. % native corn starch. The pre-gelatinized starch may be, in certain embodiments, pre-gelatinized potato starch and/or pre-gelatinized corn starch. In some forms, about the biscuit or cookie comprises 3-17 wt. % pre-gelatinized corn starch.

In some forms, a dough is provided that comprises about 3-17 wt. % pre-gelatinized starch and about 25-60 wt. % of a starch selected from the group comprising potato starch and corn starch. The dough may further comprise, in some forms, about 2 wt. % to about 40 wt. % sugar, in some forms 2-30 wt. %, and in some forms 2-20 wt. % sugar or other sweetener, about 5 wt. % to about 35 wt. % fat, and other additives. In some forms, the dough may further comprise up to about 5 wt. % wheat flour, while in other forms the dough may contain no wheat flour and be completely gluten-free. In some forms, the dough has a L* value of at least 85 upon baking. In other forms, the dough comprises one or more colorants, but would have a L* value of at least 85 upon baking but for the added colorants. During baking, the unit time heat flux (W/m²) may be around 26% to 66% less than in conventional baking in the same oven on a product with the same dimensions & moisture where color control is not an issue. In some forms, after baking the product moisture is less than about 12%, preferably less than about 4%, and in some forms the product has an Aw less than 0.66, preferably less than about 0.25. In some particular embodiments, baking may take place at about 100-140° C. for about 7.5-8 minutes.

A method of forming a baked biscuit or cookie comprises, in some embodiments, forming a mixture comprising about 3-17 wt. % pre-gelatinized starch and about 25-60 wt. % of a starch selected from the group comprising potato, corn, rice, wheat, or other starch; separating the mixture into individual units; and baking the individual units at 26% to 46% lower heat flux than normal to ensure that the resultant biscuit or cookie has a L* value of at least 85, and in some embodiments at least 86, or at least 87.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a photograph of a cookie made according to one aspect of the invention having an L* value greater than 85 compared to traditional cookies.

FIG. 2 is a photograph demonstrating improvements in coloration and dyeing by utilizing some forms of the invention.

FIG. 3 is a flow diagram illustrating one example of a method for forming and optionally packaging baked goods in some forms of the invention.

### DETAILED DESCRIPTION

It has now been shown that baked biscuits or cookies can be prepared in a manner that reduces the brown coloration normally present in baked goods. In some forms, finished products may be provided that have neutral color, and in preferred forms appear essentially white and have an average L* value of about 85 or greater according to the CIELAB color space. In some forms, the average L* value may be at least 86, and in yet other forms the average L* value may be at least 87. The CIELAB color space, also referred to as L*a*b*, is a color space defined by the International Commission on Illumination (abbreviated CIE) in 1976 that expresses color as three values: L* for perceptual lightness, and a* and b* for the four unique colors of human vision: red, green, blue, and yellow. CIELAB was intended as a perceptually uniform space, where a given numerical change corresponds to similar perceived change in color. The CIELAB color space is three-dimensional, covers the entire range of human color perception, and is based on the opponent color model of human vision (where red/green forms an opponent pair, and blue/yellow forms an opponent pair). The lightness value, L*, also referred to as “Lstar,” defines black at 0 and white at 100. The a* axis is relative to the green-red opponent colors, with negative values toward green and positive values toward red. The b* axis represents the blue-yellow opponents, with negative numbers toward blue and positive toward yellow. In some forms, the average L* value of biscuits or cookies disclosed herein may be at least 85 or at least 86, and in yet other forms the average L* value may be at least 87.

In some embodiments, one or more colorants are added to a baked good prior to or after baking to provide one or more colors in the finished baked goods. In other words, the dough is of a type capable of yielding a color-neutral biscuit or cookie, but for the addition of colorants, that avoids browning during baking, and any coloration contributed by basic structural ingredients such as flours, starches, and fibers do not substantially compete with colorant additives. As used herein, the terms “colorant” or “colorant additives” refer to one or more ingredients that are added to a dough or baked product primarily to alter the color of its appearance, and not to alter the structure or flavor of the dough or baked product. Due to the lack of brown hues in the underlying dough or underlying baked products, both before and after baking, colorants receive little to no interference and can produce vibrant colors and numerous shades heretofore unachievable in baked goods, including pastel colors, neon colors, and a wide variety of shades and gray. Colors of resultant biscuits or cookies may include, for instance, red, orange, yellow, green, blue, indigo, violet, pink, and combinations thereof. In some forms, such a biscuit or cookie can generally comprise starch, flour, fat, sweetener, and pre-gelatinized starch. The biscuit or cookie can further optionally comprise any fillings, coatings, toppings, and/or inclusions known in the art.

Generally, a biscuit or cookie can be prepared from a dough comprising pre-gelatinized starch and potato or corn starch. In some forms, the pre-gelatinized starch may comprise, for instance, about 3-17 wt. % of the dough. In some embodiments, potato starch, corn starch, or a mixture thereof comprises about 25-60% of the dough. In some forms, the dough may further comprise up to about 5 wt. % wheat flour, up to about 3 wt. % gums, and up to about 5 wt. % concentrated fiber products such as oat fiber. Water may be added in an amount sufficient to achieve a workable mixing rheology. Sugar, salt, flavorants, emulsifiers, fats, and other additives may also be added in amounts sufficient to achieve a desired flavor and texture. In some embodiments, the dough may comprise, for instance, from about 2 wt. % to about 40 wt. % sugar or other sweeteners.

In some embodiments, a gluten-free dough may be provided by omitting all wheat-based flours, starches, and fiber. In such forms, a dough may be prepared that comprises 3-17 wt. % pre-gelatinized starch, 25-60 wt. % potato starch and/or corn starch, 0-3 wt. % gums, and 0-5 wt. % concentrated fiber.

In some aspects, biscuits or cookies may comprise levels of lecithin and other emulsifiers of similar HLB (Hydrophile-Lipophile Balance) value, from about 0.1 to about 0.2 2 wt. %. In certain gluten-free embodiments, it is desirable to include relatively higher amounts of emulsifier, in some forms from 0.1 wt. % up to and including about 2.0 wt. %, in order to reduce or prevent oiling out and improve processability of gluten-free doughs.

Biscuits or cookies can be prepared from a dough including any one or more suitable fats in any suitable amounts. In some forms, the dough contains about 5-35 wt. % fat, preferably about 15-25 wt. % fat. Any fats known in the art for use in biscuits or cookies may be used. Without limitation, such fats may include solid fats or oils such as butter, canola oil, cocoa butter, coconut oil, corn oil, cottonseed oil, flaxseed oil, grape seed oil, lard, margarine, olive oil, palm kernel oil, palm oil, peanut oil, rapeseed oil, rice bran oil, safflower oil, sesame oil, soybean oil, suet, sunflower oil, tallow, vegetable oil, avocado oil, or vegetable shortening. In some aspects, a dough or biscuit can include a blend of any two or more fats. In an embodiment, a dough may comprise a vegetable-based fat (e.g. canola oil, rapeseed oil, palm oil, and/or palm kernel oil).

The dough used to form the biscuit or cookie may also have one or more suitable sweeteners in an amount effective to impart sweetness to the baked good. In some forms, biscuits or cookies may contain about 2 wt. % to about 40 wt. % sweetener, and preferably about 15-20 wt. % in the finished baked goods. Examples of sweeteners include any one or more of natural or artificial sweeteners; sugar alcohols such as sorbitol, xylitol, mannitol, maltitol, lactitol, erythritol, and the like; low or zero calorie sweeteners such as aspartame, Acesulfame potassium, Neotame, Stevia leaf extract, monk fruit extract, steviol glycosides, mogrosides, Saccharin, Sucralose, and the like; and mixtures thereof. In some aspects, sweeteners can be ground granulated, powdered (e.g. powdered or confectioners sugar), laminated, icing sugar, and the like. A dough can generally include any suitable amount of sweetener effective to assist in achieving a desired flavor profile.

In some forms, a dough may include one or more flavorants in an effective amount to impart a desired flavor profile into the finished baked product. In some forms, the flavorant may include vanillin, almond extract, coconut extract, mint extract, and combinations thereof. In some preferred forms, the flavorant is colorless or color-neutral and does not change color upon baking.

In some forms, a dough may also include one or more colorants to alter the color of the final baked product. In some embodiments, a colorant may alternatively be added after baking of the dough. Colorants used in doughs and baked products described herein may be of any type known in the art for use in edible products. Artificial and/or natural colorants may be used, for example, paprika oleoresin, annatto, beet extract, turmeric, or plant derived extracts used for color). Preferably, the dough of a biscuit or cookie does not include significant amounts of amino acids so that upon baking the resulting biscuit or cookie would have a L* value of at least 85 but for any colorants added to the dough, biscuit or cookie. In this manner, the baked product provides an essentially white base and does not interfere with color characteristics added by one or more colorants. The final baked product may thus be imparted with hues or shades that would not be possible in biscuits or cookies made with wheat flour. For instance, in some embodiments, the biscuits or cookies may be imparted with pale or deep blue, yellow, red, green, orange, or violet. In some embodiments, the biscuits or cookies may be imparted with very light hues to provide pastels of blue, yellow, pink, purple, green, or other colors. In yet other embodiments, neon-like colorants may be used to impart vivid and bright colors. In yet other embodiments, colorants may result in biscuits or cookies having various shades of gray or black. Biscuits or cookies as described herein also may have a plurality of colorants applied to a single biscuit or cookie to form multi-colored products, for instance rainbow patterns, or may have colorants applied only to certain portions in order to form patterns, shapes, or symbols of one or more colors. Alternatively, the biscuits or cookies may be substantially free of colorants in order to appear essentially white.

Other ingredients may also be optionally added. For instance, a biscuit or cookie may include about 5 wt. % to about 35 wt. % fat, about 0.2 0.01-1.0 wt. % flavorant, about 0.1-2.0 wt. % emulsifier, and about 0.50.1-2.0 wt. % bicarbonate.

A biscuit or cookie as described herein also may comprise one or more baked dough portions and one or more fillings or toppings. For instance, a cookie may comprise a sugar and/or fat-based filling sandwiched between biscuit layers, or have one or more layers of coatings, toppings, or icings. In some forms, both the dough and the filling/topping are gluten-free or low in gluten content. The biscuit or cookie may also have one or more inclusions, either in the dough portion, the filling/topping, or both. The biscuit or cookie also may be incorporated into a larger product (such as by including one or more cookie layers in a candy bar or cake product.

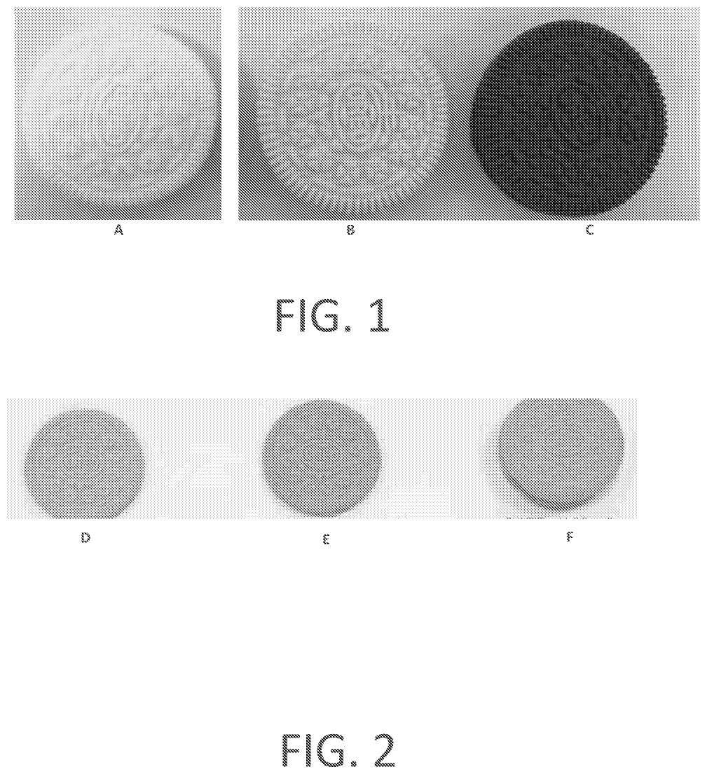

FIG. 1 shows examples of sandwich cookies made by sandwiching a crème filling between two opposed biscuit layers. The Sample A was made with potato starch and pre-gelatinized corn starch, and have an L* value above 85 so that it appears nearly white. Sample B was made using wheat flour, and as a result have a much darker, light brown appearance. Sample C is also a traditional cookie that contains more than 5 wt. % wheat flour, but has a much darker brown color due to ingredients such as cocoa powders.

FIG. 2 demonstrates the advantages of some forms of the invention in that an improved color and appearance may be achieved. Sample D has a starch base and 0.09 g carmine per 100 g starch as a colorant, resulting in a light pink appearance. By increasing the amount of carmine colorant to 0.175 g per 100 g of starch, as shown in Sample E, a much darker, bolder pink appearance is achieved. Adding the same amount of carmine to a flour based cookie (0.175 g carmine per 100 g flour) results in a less appealing, more flesh-colored tone as shown in Sample F.

A biscuit or cookie as described herein can be optionally prepared from a dough generally including one or more suitable inclusions such as sugar-based inclusions; gelatinous inclusions; chocolate chips or chunks; chocolate drops; dried or hydrated fruit; caramel; toffee; nuts such as pecans, almonds, walnuts, cashews, and peanuts; candy pieces; sugar particles of various sizes; and the like. Any suitable amount of inclusions can be added to the types of dough described herein.

In some forms, a dough includes one or more flavorants in an effective amount to impart a desired flavor profile into the finished baked product. In some forms, the flavorant may include vanillin, almond extract, coconut extract, mint extract, and combinations thereof. In some preferred forms, the flavorant is colorless or color-neutral.

A dough or finished baked good can optionally include other additives such as one or more of leaveners (e.g. ammonium bicarbonate), baking sodas (e.g. sodium bicarbonate), baking powders (e.g. ammonium phosphate), emulsifiers (e.g. lecithin), hydrocolloids/gums, preservatives, salts (e.g. sodium chloride), and whey.

A dough can generally be formed by mixing components such as water, starch, fat, sweetener, flour, leavening agent, and other optional materials. The inventors have surprisingly found that including a combination of potato and/or corn starch with pregelatinized starch provides a dough with a taste and texture similar to products with wheat flour, but that does not brown significantly upon baking.

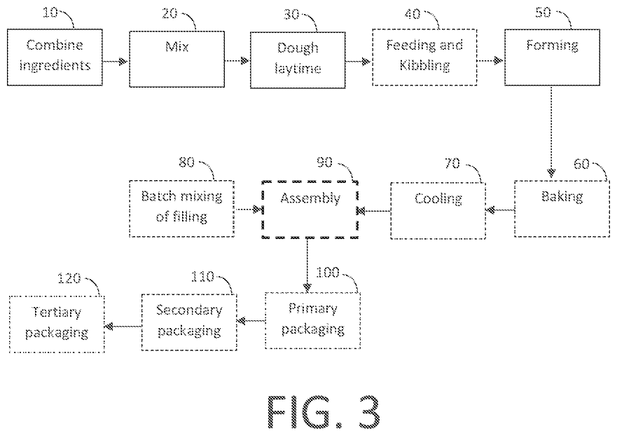

FIG. 3 shows a flow chart illustrating one example of a process for manufacturing a colorless biscuit or cookie in accordance with one embodiment of the present invention. In step 10, potato and/or corn starch, pre-gelatinized starch, water, one or more sweeteners, one or more fats, one or more emulsifiers, and other optional ingredients are combined. In step 20, the ingredients are mixed to form a homogenous mixture. In step 30, the dough is allowed to set before optionally further processing the dough, such as comminuting or kibbling (step 40) so that the dough may be formed (step 50) by rolling, molding, shaping, cutting, or other known processes. The dough is then baked (step 60), preferably under low heat and long times, and more preferably so that the unit time heat flux (W/m²) is around 26% to 66% less than it would have been for a wheat flour-based biscuit or cookie having the same dimensions and same weight baked using the same apparatus, in order to avoid discoloration but still provide desired texture. The baked dough is then allowed to cool (step 70).

If desired, a filling, topping, or coating may be separately formed, for instance by batch mixing of cream, sweeteners, and/or other ingredients (step 80), and then assembled with one or more dough portions (step 90) by injection, sandwiching, spreading, or other methods. In some forms the dough may be baked to form a finished biscuit or cookie before or after optional combination with filling.

One or more baked products are then packaged in a primary package (step 100). Optionally, secondary packaging (step 110), tertiary packaging (step 120), and any additional packaging steps are carried out as needed or desired. For instance, a primary package may contain one, several, or dozens of baked products formed according to the foregoing process, with secondary packaging gathering together several primary packages. Alternatively, the primary package may be a tray or other structure that organizes baked products into rows or other formations, with the secondary packaging being a bag or envelope that seals the primary package against the outside environment. In some other forms, the primary package may be a bag or wrapper, with the secondary packaging being a tray to organize a plurality of primary packages containing baked products. Tertiary packaging may, in some forms, group together a plurality of secondary packages.

Non-limiting examples below demonstrate further aspects of specific embodiments of the invention.

### EXAMPLES

Several cookies were produced according to the following formulation:

TABLE 1

| Flour/ | Pre- | | | | | | | Oat | Wheat | |
|---|---|---|---|---|---|---|---|---|---|---|
| Starch | gel | Sugar | Water | Vanillin | Lecithin | Fat | Gum | Fiber | Flour | Other |
| 30- | 10- | 14- | 6- | <0.1% | 0.1- | 14- | 0.3- | 1- | 0.9- | <1% |
| 40% | 16% | 16% | 17% | | 0.2% | 17% | 0.5% | 2% | 6% | |

All percentages shown above are weight percentages. The first column, labeled “Flour/Starch,” represents the amount of flour or starch other than traditional wheat flour or pre-gelatinized starch, and in some cases was a combination of starches. “Pre-gel” indicates the amount of pre-gelatinized starch (which was pre-gelatinized corn starch in all examples except in the case of Inventive Sample K, where pre-gelatinized potato starch was substituted). The “Other” column includes salt and bicarbonate. Each sample contained identical amounts of sodium bicarbonate and ammonium bicarbonate, and nearly identical amounts of salt.

The approximate amount of pre-gelatinized starch and flour/starch (other than the 10-16 wt. % pre-gelatinized starch) used for each sample varied as shown below in Table 2 (percentages indicating proportion of entire dough):

TABLE 2

| Sample ID | Flour/Starch 1 | Flour/Starch 2 | Pre-gel |
|---|---|---|---|
| Inventive A | 43% Potato Starch | — | 12% pre-gel corn starch |
| Inventive B | 46% Potato Starch | — | 12% pre-gel corn starch |
| Comparative C | 30% Potato Starch | 11% Rice Flour | 11% pre-gel corn starch |
| Inventive D | 33% Potato Starch | 11% Corn Starch | 12% pre-gel corn starch |
| Comparative E | 30% Potato Starch | 11% Mod. Corn Starch | 11% pre-gel corn starch |
| Inventive F | 32% Potato Starch | 11% Tapioca Starch | 12% pre-gel corn starch |
| Comparative G | 43% Tapioca Starch | — | 11% pre-gel corn starch |
| Comparative H | 41% Rice Flour | — | 11% pre-gel corn starch |
| Inventive I | 39% Corn Starch | — | 11% pre-gel corn starch |
| Inventive J | 39% Corn Starch | — | 11% pre-gel corn starch |
| Inventive K | 43% Potato Starch | — | 12% pre-gel potato starch |
| (pre-gel potato | | | |
| starch) | | | |

All samples contained 1.5-3 wt. % wheat flour, except Samples B (0 wt. % wheat flour), I (5.4 wt. % wheat flour), and J (0% wheat flour). Samples C and H, each containing rice flour, required significantly more water (13-17 wt. %) than the other samples to attain comparable mixing rheology. All other samples contained 6-11 wt. % water. Samples A-J contained pre-gel corn starch, while Sample K contained pre-gel potato starch.

The above samples were compared and evaluated according to color and breakability (3-point bend).

Results of color analysis are shown below in Table 3. All samples were evaluated by Hunterlab Colorimeter, D25NC with 12 inch rotating pan, with sensor-to-pan distance of 95 mm, 38-40 pieces per read.

TABLE 3

| Sample ID | Flour/Starch | L* Value | moisture |
|---|---|---|---|
| Inventive A | 43% Potato Starch | 86.52-87.08 | 1.7-2.8 |
| Inventive B | 46% Potato Starch | 87.63 | 1.7-2.8 |
| Comparative C | 30% Potato Starch, | 83.39 | 2.4 |
| | 11% Rice Flour | | |
| Inventive D | 33% Potato Starch, | 88.23 | 2.7 |
| | 11% Corn Starch | | |
| Comparative E | 30% Potato Starch, | 83.6 | 3.4 |
| | 11% Mod. Corn | | |
| | Starch | | |
| Inventive F | 32% Potato Starch, | 86.46 | 2.7 |
| | 11% Tapioca Starch | | |
| Comparative G | 43% Tapioca Starch | 77.16 | 3.2 |
| Comparative H | 41% Rice Flour | 80.20 | 3 |
| Inventive I | 39% Corn Starch | 85.29 | 2.3 |
| Inventive J | 39% Corn Starch | 87.2 | 2.6 |
| Inventive K | 43% Potato Starch | 87.74 | 2.3 |

As can be seen from the above, it was surprisingly found that samples containing native potato starch and/or corn starch in place of wheat flour achieved a L* value of 85 or greater. Samples containing primarily rice flour or tapioca starch as a replacement for wheat flour were unable to achieve the same level of whiteness.

Testing Samples A-K for three-point bend (3PB) showed that all of Inventive Samples A-B, D-F, and I-K and had average 3PB of 560-1100. For comparison, a commercially-available cookie was tested and determined to have an average 3PB of 991. Results of 3PB testing are shown below in Table 4:

TABLE 4

| Sample ID | Flour/Starch | 3PB Max Force (G) |
|---|---|---|
| Inventive A | 43% Potato Starch | 723-883 |
| Inventive B | 46% Potato Starch | 830 |
| Comparative C | 30% Potato Starch, | 841 |
| | 11% Rice Flour | |
| Inventive D | 33% Potato Starch, | 767 |
| | 11% Corn Starch | |
| Comparative E | 30% Potato Starch, | 1143 |
| | 11% Mod. Corn Starch | |
| Inventive F | 32% Potato Starch, | 839 |
| | 11% Tapioca Starch | |
| Comparative G | 43% Tapioca Starch | 1032 |
| Comparative H | 41% Rice Flour | 1990 |
| Inventive I | 39% Corn Starch | 1064 |
| Inventive J | 39% Corn Starch | 1015 |
| Inventive K | 43% Potato Starch | 562 |

All three-point bend measurements were made using Stable Micro Systems TA.XT Plus texture analyser with a 5 kg load cell, using 30 pieces per sample. Testing parameters are shown below in Table 5. These results show that the inventive samples had comparable texture to commercially available cookies having a similar formulation but containing wheat flour. Sample K, however, which contained pre-gelatinized potato starch in place of pre-gelatinized corn starch, had a lower 3PB than other inventive samples.

TABLE 5

| Test | | Trigger | Trigger | Target |
|---|---|---|---|---|
| Mode | Tooling | Type | Force | Mode |
| Compression | HDP/3PB | Auto (Force) | 20 g | Distance |

| | Pre-Test | Test | Post-Test | Adv. |
|---|---|---|---|---|
| Distance | Speed | Speed | Speed | Mode |
| 6 mm | 0.8 mm/sec | 0.8 mm/sec | 10 mm/sec | Off |

Additional samples were prepared to demonstrate the effect of changing the amount of pre-gel starch. Sample L contained 39 wt. % potato starch and 15.2 wt. % pre-gel corn starch, and achieved an average 3PB of 1057 G with a L* value of 86.01 Sample M contained 46.5 wt. % potato starch and 8.1 wt. % corn starch, and achieved an average 3PB of 700 G with a L* value of 87.46. This demonstrates that the amount of pre-gelatinized starch may be varied in order to adjust hardness to a desirable level while still maintaining an essentially white appearance.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A fully baked biscuit or cookie comprising about 3-17 wt. % pre-gelatinized starch and about 25-60 wt. % of a starch selected from the group comprising potato starch and corn starch, the biscuit or cookie having a L* of 85-100.

2. The biscuit or cookie according to claim 1, further comprising 0-5 wt. % wheat flour.

3. A gluten-free biscuit or cookie according to claim 1.

4. The biscuit or cookie according to claim 1, further comprising 0.5-3 wt. % gums.

5. The biscuit or cookie according to claim 1, further comprising 1-5 wt. % oat fiber.

6. The biscuit or cookie according to claim 1, wherein the pre-gelatinized starch is pre-gelatinized corn starch.

7. The biscuit or cookie according to claim 1, wherein the starch is native corn starch.

8. The biscuit or cookie of claim 1, further comprising about 3-17 wt. % pre-gelatinized corn starch and about 25-60 wt. % native corn starch.

9. A dough comprising about 3-17 wt. % pre-gelatinized starch and about 25-60 wt. % of a native starch selected from the group comprising potato starch and corn starch, about 1 wt. % to about 40 wt. % sugar or other sweetener, and about 5 wt. % to about 35 wt. % fat.

10. The dough of claim 9, further comprising about 0-5 wt. % wheat flour.

11. A gluten-free dough according to claim 9.

12. The dough of claim 9, further comprising about 0.5-3 wt. % gums and about 1-5 wt. % oat fiber.

13. The dough of claim 9, wherein the dough has a L* value of at least 85 upon baking at 100-140° C. for 7.5-8 minutes.

14. The dough of claim 9, further comprising a colorant, and wherein the dough would have a L* value of 85-100 upon baking at 100-140° C. for 7.5-8 minutes but for presence of the colorant.

15. A method of forming a baked biscuit or cookie, the method comprising:
forming a mixture comprising about 3-17 wt. % pre-gelatinized starch and about 25-60 wt. % of a starch selected from the group comprising potato starch and corn starch;
separating the mixture into individual units;
baking the individual units at a unit time heat flux (W/m²) that is from 26% to 66% less than in conventional baking in the same oven on a product with the same dimensions & moisture; and
forming upon baking a biscuit or cookie having a L* value of 85-100.

16. The method of claim 15, wherein the mixture further comprises 1-5 wt. % wheat flour.

17. The method of claim 15, wherein the mixture does not contain gluten.

18. The method of claim 15, wherein the mixture further comprises a colorant.

19. The method of claim 15, wherein the mixture further comprises native corn starch.

20. The method of claim 15, wherein the mixture further comprises about 3-17 wt. % pre-gelatinized corn starch and about 25-60 wt. % native corn starch.
